(19) United States
(12) Patent Application Publication
(10) Pub. No.: US 2006/0209321 A1
(43) Pub. Date: Sep. 21, 2006

(54) Image forming apparatus and method and an operation apparatus for image forming

(75) Inventor: Kunihiro Nakagawa, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,376

(22) Filed: Mar. 15, 2005

(51) Int. Cl. G06F 15/00

(52) U.S. Cl. 358/1.9; 358/518; 382/167

(57) ABSTRACT

Only a specific color on the monitor can be specified as an arbitrary print color. In addition, a printed image where the specified color has been faithfully reproduced can be obtained, which enables a clear color image to be printed. When the correlation between a color in the RGB space and any color in the CMYK space or setting information that specifies whether to perform an ink-in process is input, a specified color decision section 211 makes a decision on this. A color replacement section 220 executes a color replacement process according to the setting information. If color replacement is not performed, a color conversion section 212 carries out a printer color conversion process in the printer normal operation.

### BACKGROUND OF THE INVENTION

1. Field of the Invention

This invention relates to an image forming apparatus and method and an apparatus for operating the image forming apparatus, and more particularly to an apparatus which enables the colors of printed images to be faithfully reproduced with the favorite hues specified by the user.

2. Description of the Related Art

In an image forming apparatus, print data is sent from a personal computer (hereinafter, referred to as PC) to a printer via a network. Then, the printer forms and outputs print images on the basis of the print data. The PC is provided with a printer driver. The printer driver sends the print data to the printer. In the printer, a printer controller converts the received print data into printing image data suitable for printing. The converted printing image data is subjected to an image forming process at a printer engine, which composes print images on the paper.

More specifically, the printer driver converts print data (object information (Image/Graphics/Text)) into print setting information and page descriptive language (hereinafter, referred to as PDL) and sends these to a printer controller on the network. According to the print setting information written in PDL, the print controller subjects the print data to image processes, including color conversion, thereby obtaining printing image data. This printing image data is formed as a print image on the paper by the printer engine.

The printer makes prints using Cyan, Magenta, and Yellow, or the three primary colors, and Black as color materials. In contrast, images displayed on the monitor of a personal computer are represented using red (R), green (G), and blue (B) data. Therefore, when read (R), green (G), and blue (B) data are used as print data, the color space of print data has to be converted into a CMY color space (CMYK color space) at the color conversion section of the printer controller.

Here, the hues of Cyan/Magenta/Yellow toners does not coincide completely with the hues of Cyan/Magenta/Yellow on the monitor. The reason is that the CMY color space of the printer differs from the RGB color space of the monitor in the color reproduction range. Therefore, when the color conversion section of the printer controller performs RGB→CMY color conversion, the hues, brightness, and the like are adjusted automatically.

Therefore, even when the user specifies pure colors (Cyan, Magenta, Yellow) on the monitor, there is no guarantee that they will be output using single-color toners. In this case, depending on the characteristics of the printer, toners of two or more colors are laid one on top of another, thereby forming an image. Therefore, the colors of the image can make muddiness and roughness more conspicuous than when the image is printed in single colors.

### BRIEF SUMMARY OF THE INVENTION

An object of the embodiments is to provide an image forming apparatus and method which enable only specific colors on the monitor to be specified as arbitrary printing colors, print images with faithfully reproduced specified colors to be obtained, and pure color images to be printed, and an apparatus of operating the image forming apparatus.

According to an aspect of the embodiments, when the correlation between a color in the RGB space and any color in the CMYK space or setting information that specifies whether to perform an ink-in process is input, a color replacement process according to the setting information or an ink-in process is carried out. If neither a color replacement process nor an ink-in process is carried out, a printer color conversion process in a printer normal operation is carried out.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows the overall configuration of a personal computer and an image forming apparatus to which the present invention has been applied;

FIG. 2 is a diagram of an RGB space and a CMY space to help explain the present invention;

FIG. 3 shows a vector relationship diagram to help explain the operation of the specified decision section of FIG. 1;

FIG. 4 is a diagram to help explain the correlation between colors in the RGB space and those in the CMY space;

FIG. 5 is a diagram to help explain a color replacement process to describe the operation of the color replacement section of FIG. 1;

FIG. 6 is an explanatory diagram of an example of screens displayed on the monitor on the personal computer side of FIG. 1;

FIG. 7 is an explanatory diagram showing the configuration of one other embodiment of the present invention; and

FIG. 8 is an explanatory diagram to help explain the correlation between colors in the RGB space and those in the CMY space in the one other embodiment.

### DETAILED DESCRIPTION OF THE INVENTION

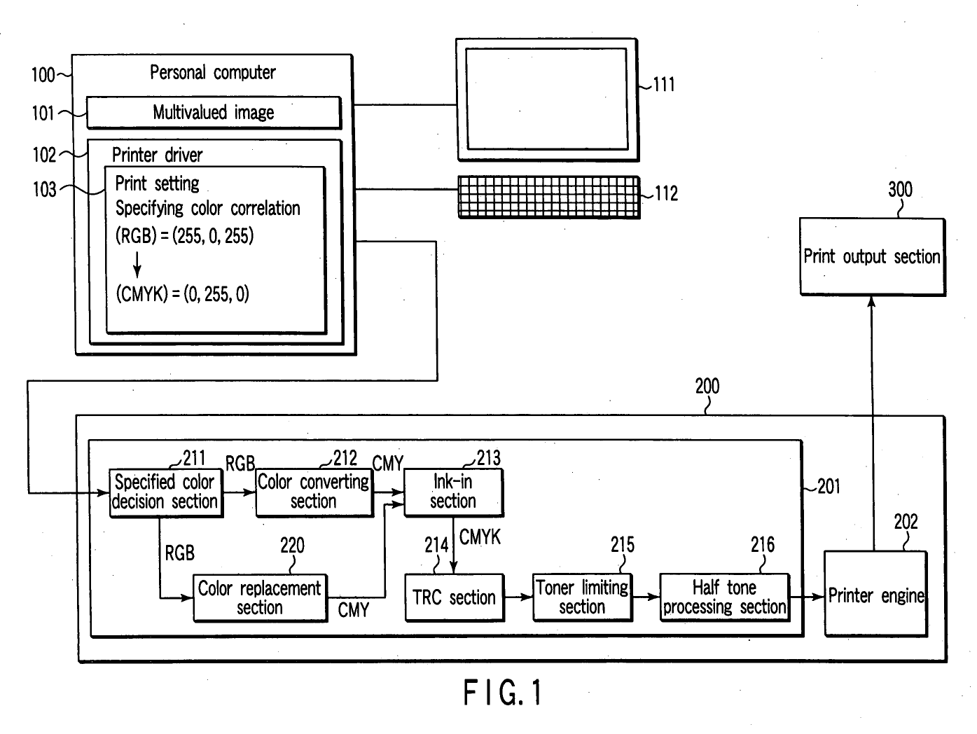

Hereinafter, referring to the accompanying drawings, an embodiment of the present invention will be explained. FIG. 1 shows a schematic configuration of an image forming apparatus to which the present invention has been applied and an apparatus for operating the image forming apparatus. Numeral 100 indicates a personal computer acting as an operation apparatus. Numeral 200 indicates the image forming apparatus. The image forming apparatus includes a printer and a copying machine.

The PC 200 is provided with an image processing section 101 and a printer driver 102. In the printer driver 102, there is provided a print setting section 103. The processing state of the print setting section 103 can be checked on the screen of a monitor 111 as described later. While looking at the screen of the monitor 111, the user performs print setting by operating an operation section (including a mouse) 112.

The multivalued image data, that is, red (R), green (G), and blue (B) image data (hereinafter, referred to as RGB image data), and the print setting information (information about the layout, hue, density, and others for printing) set in the printer driver 102 is sent to a printer controller 201 of the image forming apparatus 100 via a network.

The RGB image data and print setting information from the personal computer 100 are input via an input terminal and an interface to a specified color decision section 211. The specified color decision section 211 determines whether the print setting information includes pure color specification. This function is unique to the apparatus of the present invention. Therefore, pure color specification will be explained in detail later.

When there is no pure color specification, the specified color decision section 211 carries out a normal route signal process. Specifically, the RGB image data from the specified color decision section 211 is converted into printing image data, that is, CMY image data at a color converting section 212.

In addition, black (K) image data is added to the CMY image data at an ink-in section 213, thereby converting the CMY image data into CMYK image data, which is then output. The CMYK image data is input to a tone reproduction curve (TRC) section 214 for setting the amount of toner adhesion for each color of CMY and is therefore converted into CMYK image data with the set amount of toner adhesion. The CMYK image data with the set amount of toner adhesion is input to a toner limiting section 215, which imposes limitations on the area where an excess amount of toner adhesion exist, and outputs the resulting data.

The CMYK image data output from the toner limiting section 215 is input to a half tone processing section 216 for printing, which subjects the CMYK image data to a tone representation process and outputs the resulting data to a printer engine 202. The printer engine 202 drives a print output section 300 on the basis of CMYK image data.

When the specified color decision section 211 has determined that there is pure color specification in the print setting information, the RGB image data from the personal computer 100 is processed at a color replacement section 220. The CMY image data replaced here is input to the ink-in section 213. The processes from this point on are as described above.

Next, the function realized by the specified color decision section 211 and color replacement section 220 will be explained in further detail. This function enables the printer driver 102 to cause only specific colors on the monitor 111 to correspond to the colors in the printer output. As a result, the printer controller 201 performs the operation of switching between an RGB→CMY color conversion system in normal printing and a color replacement system based on the correlation specified by the driver.

This enables only specific colors on the monitor to be output in arbitrary colors and pure colors to be specified and output.

From this time on, the function of causing a color on the monitor to correspond to a color on the printer and replacing one with the other is called a Pure Color process.

Similar functions include a Pure Black process of converting (R, G, B)=(0, 0, 0) into (C, M, Y, K) (0, 0, 0, 255) and a Pure Gray process of converting (R, G, B)=(x, x, x) into (C, M, Y, K)=(0, 0, 0, 255−x) (where 1≦x≦255). With the present invention, even chromatic colors can be output in pure printer colors. In addition, as frequently found in the Pure Black/Pure Gray processes, ON/OFF of the processing functions can be specified according to the object attributes.

In the explanation below, it is assumed that each color is specified by eight bits in both of the RGB color space on the personal computer (PC) 100 and the CMYK color space on the printer. A color in the RGB space subjected to the Pure Color process is referred to as a specified color.

As a first example, the process of replacing an arbitrary color on the monitor with a pure color on the printer will be explained. The effect of the first example is that only the colors on a straight line connecting white color to the color specified by the driver in the RGB color space can be output in pure colors on the printer.

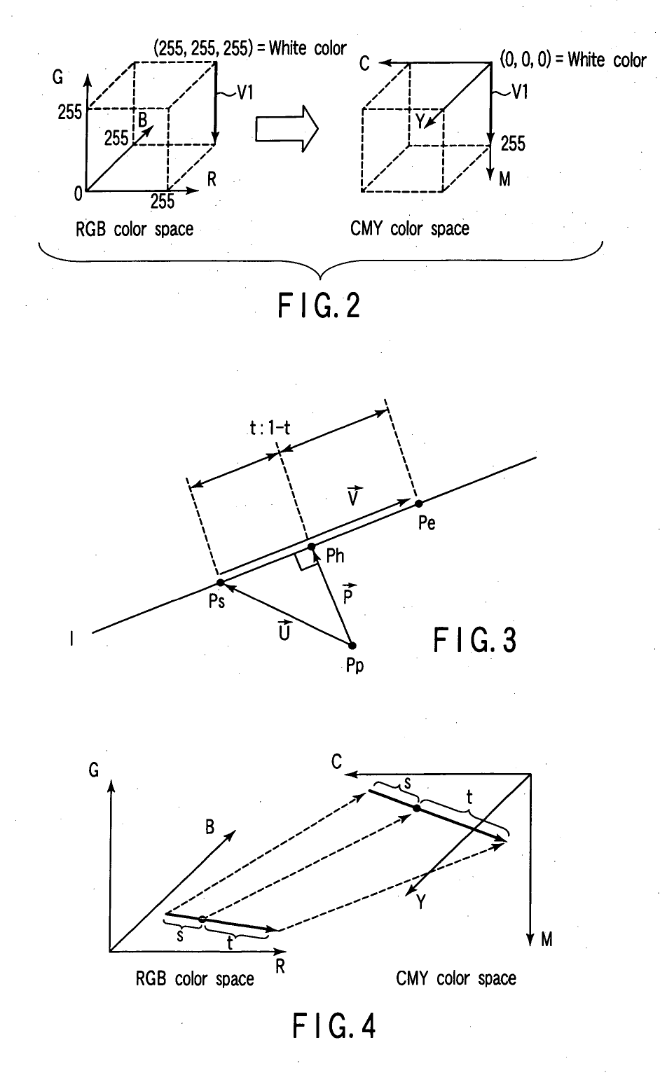

FIG. 2 shows the color RGB-CMY correlation illustrated in FIG. 1. The RGB space is shown on the left side and the CMY space corresponding to the RGB space is shown on the right side. In the first example, on the printer driver 102, an arbitrary RGB value (R, G, B) and any one of the printer pure colors Cyan/Magenta/Yellow are specified first. At this time, the computing process is carried out which causes a straight line connecting (255, 255, 255) to (R, G, B) in the RGB space to correspond to a straight line connecting (0, 0, 0) to (C, M, Y) (only one of C/M/Y is 255 and the rest are 0s).

FIG. 2 shows an example of vector V1 when Magenta ((RGB)=(255, 0, 255)) on the monitor screen and pure Magenta ((CMY)=(0, 255, 0) on the printer are specified. In this example, the colors on a straight line connecting white to Magenta in the RGB space (the colors on vector V1 in the RGB space of FIG. 2) are caused to correspond to the colors on a straight line connecting white to Magenta in the CMY space (the colors on red vector V1 in the CMY space of FIG. 2), thereby carrying out a Pure Color process.

The printer driver 102 transmits the image data together with Pure color setting information to the printer controller 201. Next, the printer controller 201 causes the specified color decision section 211 to determine whether the pixel value of the image data indicates the specified color and switches the process. If the pixel value of the image data indicates the specified color, the printer controller 201 takes the route of the color replacement section 220, thereby carrying out a color replacement process according to the Pure Color correlation. If the pixel value of the image data indicates a color other than the specified color, the printer controller 201 takes the route of the color converting section 212, thereby performing RGB→CMY color conversion in a normal print operation.

When the distance between the straight line in the RGB space specified by the driver and the pixel value of the input image is smaller than one, the specified color decision section 211 determines that the pixel value is on the straight line and indicates the specified value. Then, equation 1 given below is calculated, thereby determining the distance between the straight line and the point.

FIG. 3 shows the relationship between the variables in the equation and the vector. In the specification, a vector is represented as a symbol followed by →. In the figure, → is added to above a symbol.

Now, let the starting point and ending point of a straight line in the RGB color space be Ps and Pe, respectively, and the straight line passing Ps and Pe be l. Let the pixel value of an input image be Pp. Let a vector from Pp to Ps be U→ and a vector from Ps to Pe be V→.

If a point on l is Ph, a vector P→ from Pp to Ph is represented as V→+tV→ using a real number t. At this time, t indicates the distance from Ps to Ph.

If Ph is the leg of a vertical line lowered from Pp with respect to the straight line passing Ps and Pe, the inner product of vector P→ and vector V→ is 0 and the following equations hold:
P→·V→=0
(U→+tV→)·V→=0
t=U→·V→/V→·V→ (Equation 1)

From t, vector P→, a vertical line from Pp to 1 can be determined. At this time, t represents the distance from Ps to Ph and ∥P→∥ represents the distance from l to Pp. If 0<t<1 and ∥P→∥<1, the specified color decision section 211 determines that the pixel value of the image data indicates the specified color.

The pixel determined to be the specified color is caused to correspond to the CMYK space at the color replacement section 220. In the first example, however, the K axis is not used because correlation is specified in the CMY color space.

Color correlation is performed by correlating the internally dividing point on the straight line in the RGB space with a point that divides a straight line in the same ratio in the CMYK space.

FIG. 4 shows a conceptual diagram of correlation. For simplification, the K axis is omitted in FIG. 4. A color in a position that internally divides a straight line in the RGB space in the ratio of s:t is caused to correspond to the color in the position that internally divides a straight line in the CMY space in the ratio of s:t. The color replacement section 220 performs color replacement using the value of valuable t calculated at the specified color decision section 211.

Using equation 2, a color after replacement can be determined. Here, let the starting point of a straight line in the CMYK color space be vector W→ (C1, M1, Y1, K1) and the ending point be vector X→ (C2, M2, Y2, K2). Let the pixel value after replacement be vector Z− (C, M, Y, K). In the first embodiment, K1=K2=K=0.

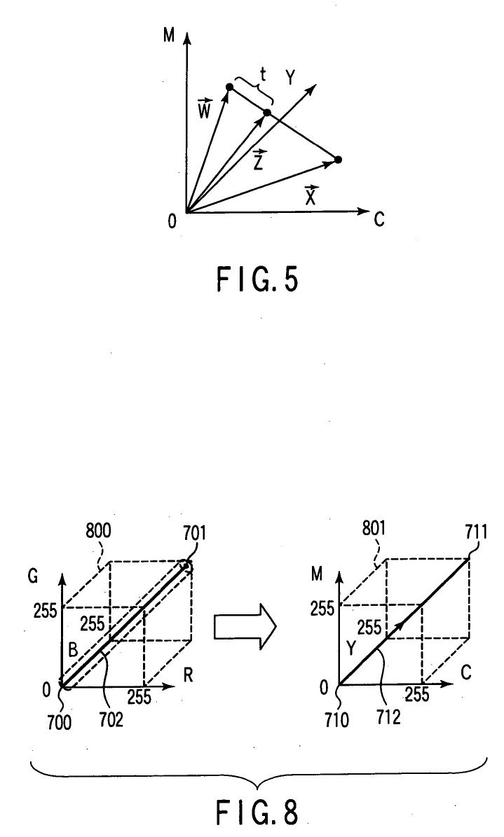

FIG. 5 shows the relationship between the variables in equation 2 and vectors. For the sake of simplification, K axis is omitted.
Z→=W→+t(X→−W→) (Equation 2)

In the example of correlation shown in FIG. 2, by the specified color decision and color replacement processes, the pixel values meeting (R, G, B)=(255, x, 255) are replaced with (C, M, Y)=(0, 255−x, 0), where 0≦x≦255.

The present invention is not limited to the above embodiment.

As a second example, the process of causing an arbitrary color on the monitor to an arbitrary color on the printer will be explained. In the first example, pure colors on the printer have been used as clear colors. Since it is conceivable that a color which makes muddiness and roughness more conspicuous differs, depending on the characteristics of the printer, the colors specified as clear colors may be expanded.

In the second example, the definition of a clear color is expanded, which makes it possible to use a color not including K ((c, m, y, 0)): 0≦c, m, y≦255) or a color to which half tone is not applied ((c, m, y, k): c, m, y, k are each 0 or 255).

First, a Pure Color process, including color correlation on the printer driver 102 of the PC 100, is set.

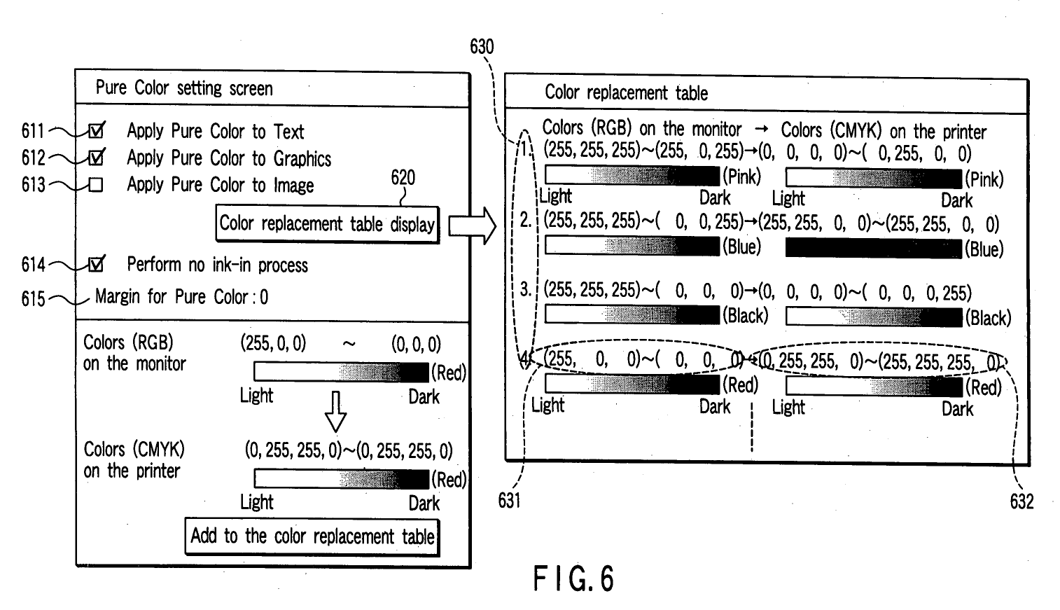

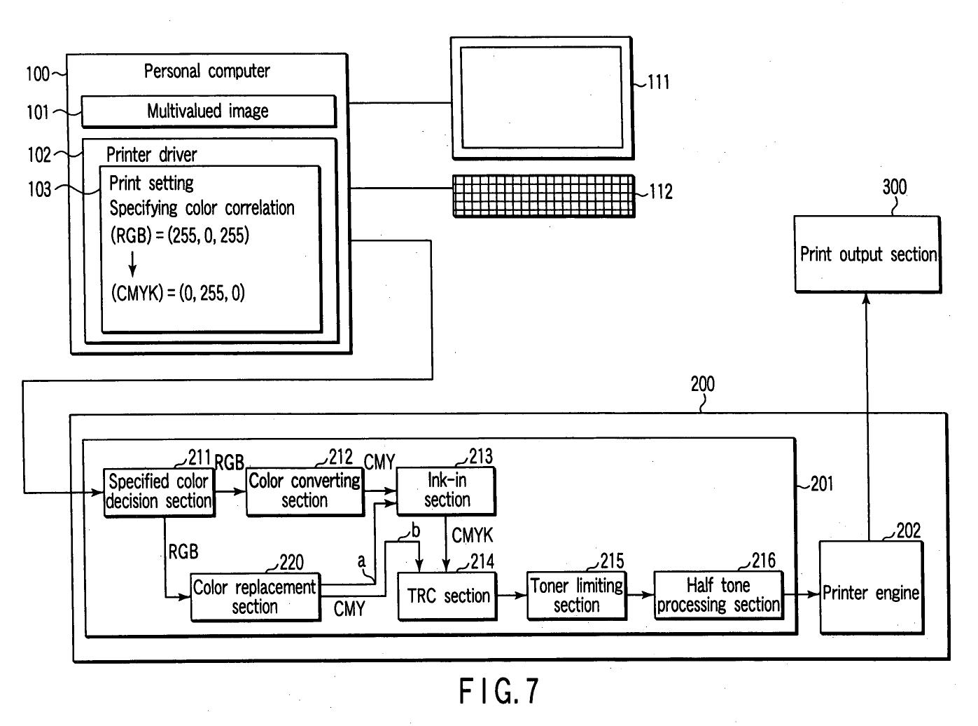

FIG. 6 shows a screen for Pure Color setting performed by the driver. FIG. 7 shows the flow of the processing. The driver can perform the following four types of setting.

1. Pure Color ON/OFF Setting for Each Object

Whether to carry out a Pure Color process can be set for each of the following objects: Text, Graphics, and Image.

In the example of FIG. 6, setting is done so as to subject Text and Graphics to a Pure color process and not to subject Image to this process. Check boxes 611, 612 are checked and check box 613 is blank. That is

2. Specifying an Ink Creating Method

To suppress the consumption of CMY toners, the color printer generally creates K data from the CMY data at the ink-in section 213 of the printer controller 201 and prints in four colors of CMYK. The following equations and others are used in the process of the ink-in section 213. Suppose C, M, Y are the pixel values before an ink-in operation, C′, M′, Y′, K′ are the pixel values after an ink-in operation, and min(x, y, z) are the minimum values of x, y, z.
C′=C−min(C, M, Y)
M′=M−min(C, M, Y)
Y′=Y−min(C, M, Y)
K′=min(C, M, Y)

Since the ink-in section creates K data, when a color not including K is used as a clear color, it has to be prevented from passing through the ink-in section.

To achieve this, whether to carry out an ink-in process is specified in the setting of the printer driver. In the example of the setting screen of FIG. 6, the check box for “Ink-in process is not performed” is used to prevent the data from passing through the ink-in section. The check box 614 is checked, thereby specifying “Ink-in process is not performed.”

3. Specifying the Range of a Specified Color

In this apparatus, the colors on a straight line in the RGB color space are caused to correspond to a straight line in the CMY color space as shown in FIG. 2 of the first embodiment.

Here, changing the method of specifying a color in the RGB space from a straight line to a cylindrical column makes it possible to roughly specify a color. At this time, the radius of the cylindrical column can be set. In the setting screen of FIG. 6, the radius is specified by the value following “A margin for errors in Pure Color” as written in item 615. In this case, since “0” has been input, a straight line is specified as a color replacement characteristic.

FIG. 8 shows a case where the vicinity of an achromatic color in the RGB color space 800 is caused to correspond to an achromatic color in the CMY color space 801. Colors inside a cylindrical column 702 in the RGB color space 800 are caused to correspond to a straight line 712 in the CMY color space 801. FIG. 8 shows that cylindrical column 702 is on a line connecting a point 700 and a point 701 in the space 800 and a margin for errors has been set.

4. Color Replacement Correlation

For color replacement correlation, a straight line in the RGB color space and a straight line in the CMYK color space are specified. A plurality of correlations can be registered. Although not shown in FIG. 6, the order of priority is set uniquely. When a color in the RGB space corresponds to a plurality of correlations, the correlation with the highest priority is used.

FIG. 6 shows a case where four correlations have been registered in a color replacement table 630 at right. Specifically, on the monitor screen, when item 620, that is, “Color replacement table display,” is clicked, the present screen is changed to the screen at right. On this screen, four color bars are displayed and the colors on the monitor at left are compared with the colors on the printer at right. Since the drawing is monochromatic, colors are not shown. However, in each of the color bars, the left side is shown lighter and the right side is shown darker. In addition, numeral 1 indicates pink, 2 blue, 3 black, and 4 red. The end-points of a straight line in each of the RGB color space and CMY color space are written.

Furthermore, in the color replacement table, a color can be added. In the example of FIG. 6, red is added. The numbers enclosed by a dotted line 630 are table registration numbers. The numbers enclosed by a dotted line 631 are information (addresses) about both of the end-points of a characteristic straight line in the RGB space. The numbers enclosed by a dotted line 632 are information (addresses) about both of the end-points of a characteristic straight line in the RGB space. These values can be modified to specify one point in the RGB space (monitor color space) and cause the point to correspond to the maximum density of pure colors (C, M, Y) on the printer side.

Hereinafter, the effect of correlations registered in the color replacement table of FIG. 6 will be explained.

Registration number 1: Magenta displayed on the monitor can be replaced with a pure color on the printer as in the first embodiment.

Registration number 2: The halftone of blue is replaced with dense blue to which halftone cannot be applied, that is, solid blue.

Registration number 3: An achromatic color is replaced with a monochromatic color K, which produces the same effect as that of the Pure Gray/Pure Black processes.

Registration number 4: To avoid roughness due to the color mixture of black, the gradation from red to black is printed using only CMY.

Next, on the basis of the Pure Color setting of the driver, the printer controller performs processing. The specified color decision section 211 determines the distance ∥P→∥ between the straight line in the RGB space to the pixel value using equation 1. If 0<t<1 and ∥P→∥<(1+the allowable range of the specified color), the specified color decision section 211 determines that it is the specified color.

The color determined to be the specified color is replaced with a color in the CMYK space at the color replacement section 220 using equation 2. The pixel value (C, M, Y, K) caused to correspond to the CMYK space is subjected to a different subsequent process, depending on the ink creating method specified in the driver setting. If an ink-in process is not carried out, (C, M, Y, K) data is input via line b to the TRC section 214 immediately after an ink-in operation as shown in the figure. If an ink-in process is carried out, (C, M, Y, K) data takes the route of line a. Then, the (C, M, Y) data from which K has been removed is input to the ink-in section 213.

By the above process, an arbitrary color on the monitor (or in the RGB color space) can be caused to correspond to an arbitrary color on the printer (or in the CMYK color space).

As described above, only the colors specified by the user in the RGB space are replaced with pure colors on the printer without RGB→CMY color conversion normally performed on the printer, which enables specific colors to be output in clear pure colors. In addition, an arbitrary color on the monitor is caused to correspond to an arbitrary color on the printer, which makes it possible to cause an arbitrary color on the monitor to correspond to three or more printer pure colors. Furthermore, specifying the black creating method makes it possible to suppress the color mixture of black liable to cause roughness.

As described above, the apparatus of the present invention includes basic elements described below.

When printing, the user can specify whether to cause colors in the RGB space to correspond to colors in the CMYK space, or whether to carry out an ink-in process. According to the user's specification, the printer controller replaces colors according to the correlation if they are the colors specified by the user. If not, the printer controller carries out a printer color conversion process in a printer normal operation. Furthermore, the colors in the CMYK space created on the basis of the correlation specified by the user can be subjected to an ink-in process according to an instruction to carry out an ink-in process given by the user.

Specifically, when printing, the user can cause colors in the RGB space (monitor color space) to correspond to pure colors (C, M, Y) on the printer. When the printer controller performs color conversion from RGB to CMYK, the gradation from the specified color to white in the RGB space is replaced with the gradation from a pure color to white on the printer. For a color which does not gradate from the specified color to white, the printer controller performs color conversion from RGB to CMYK in a printer normal operation.

Furthermore, with the invention, when printing, the user can specify a straight line in the RGB space (monitor color space) and its vicinity, thereby causing them to correspond to a straight line in the CMYK space (printer color space). Moreover, the user can specify whether to perform an ink-in process.

The printer controller replaces colors on the straight line and in its vicinity in the RGB color space with colors on a straight line in the CMYK color space. Then, the colors excluding those in the vicinity of the specified straight line are subjected to color conversion from RGB to CMYK in a printer normal operation.

When an ink-in process is carried out, the colors in the CYMK space created by the user-specified color replacement are input to the ink-in section, thereby creating K. When an ink-in process is not carried out, the CMYK data is input to the process immediately after the ink-in section.

Furthermore, with the present invention, when printing, the user can specify one point in the RGB space (monitor color space) and cause the point to correspond to the maximum density of printer pure colors (C, M, Y). When the printer controller performs color conversion from RGB to CMYK, it replaces the colors on a straight line connecting the specified color to white in the RGB space with the colors on a straight line connecting the maximum density of the printer pure color to white. The colors not on the straight line connecting the specified color to white in the RGB space are subjected to color conversion from RGB to CMYK in a printer normal operation.

Furthermore, with this invention, when printing, the user can specify two points in the RGB space, a margin for the color specification range, and two points in the CMYK space. This specification causes the characteristic of a straight line and colors in its vicinity in the RGB space to correspond to the characteristic of a straight line in the CMYK space. Moreover, the user can specify whether to perform an ink-in process.

The printer controller replaces colors on the straight line and in its vicinity in the RGB color space specified by the user with colors on a straight line in the CMYK color space according to a ratio internally dividing the straight line. The colors excluding those in the vicinity of the specified straight line in the RGB space are subjected to color conversion from RGB to CMYK in a printer normal operation.

When an ink-in process is carried out, the colors in the CYMK space created by the user-specified color replacement are input to the ink-in section, thereby creating K. When an ink-in process is not carried out, the CMYK data is input to the process immediately after the ink-in section.

This invention is not limited to the above embodiments and may be practiced or embodied in still other ways without departing from the spirit or essential character thereof. In addition, various inventions may be configured by suitably combining a plurality of component elements disclosed in the embodiments. For instance, some component elements may be eliminated from all of the component element shown in each of the embodiments. Furthermore, the component elements related to different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming method of converting color image data in an RGB space into color image data in a CMY space, the image forming method comprising:
taking in RGB image data in the RGB space;
determining whether print setting information includes specified color information that indicates at least a correlation between any color (specific color) in the RGB space and any color (specific color) in a CMYK space;
subjecting only the specific color specified in the specified color information in the RGB image data to a color replacement process on the basis of a specific arithmetic expression, if the print setting information includes the specified color information, thereby converting only the specific color into CMY image data; and
correlatively converting a preset color in the RGB space into a color in the CMYK space if the specified color information is not detected.

2. The image forming method according to claim 1, further comprising, when the print setting information includes information that specifies the execution of an ink-in process, performing an ink-in process on the CMY image data subjected to the color replacement process, thereby obtaining CMYK image data.

3. The image forming method according to claim 1, wherein the print setting information includes information that specifies an object to be subjected to the color replacement process.

4. The image forming method according to claim 1, wherein the step of converting into CMY image data by the color replacement process is to replace the gradation from the specified color to white in the RGB space with the gradation from a pure color on the printer side corresponding to the specified color to white.

5. The image forming method according to claim 1, wherein the step of converting into CMY image data by the color replacement process is to replace colors on a straight line and in its vicinity in the RGB space with colors on a straight line in a CMYK color space.

6. An image forming apparatus which converts color image data in an RGB space into color image data in a CMY space, the image forming apparatus comprising:
a terminal which takes in RGB image data in the RGB space;
a specified color decision section which determines whether print setting information includes specified color information that indicates at least a correlation between any color (specific color) in the RGB space and any color (specific color) in a CMYK space;
a color replacement section which, if the print setting information includes the specified color information, subjects only the specific color specified in the specified color information in the RGB image data to a color replacement process on the basis of a specific arithmetic expression, thereby converting only the specific color into CMY image data; and
a color conversion section which, if the specified color information is not detected, correlatively converts a preset color in the RGB space into a color in the CMYK space.

7. The image forming apparatus according to claim 6, further comprising an ink-in section, when the print setting information includes information that specifies the execution of an ink-in process, performs an ink-in process on the CMY image data subjected to the color replacement process.

8. The image forming apparatus according to claim 6, wherein the color replacement section, when the print setting information includes information that specifies an object to be subjected to the color replacement process, subjects the specified object to a color replacement process.

9. The image forming apparatus according to claim 6, wherein the color replacement section replaces the gradation from the specified color to white in the RGB space with the gradation from a pure color on the printer side corresponding to the specified color to white.

10. The image forming apparatus according to claim 6, wherein the color replacement section replaces colors on a straight line and in its vicinity in the RGB space with colors on a straight line in a CMYK color space.

11. An operation apparatus with a printer driver which outputs RGB image data in the RGB space to the image forming apparatus according to claim 6, the operation apparatus comprising:
a monitor which displays a setting screen for setting print setting information; and
means for displaying a menu screen for specifying an object to reflect the specific color on the screen of the monitor.

12. The operation apparatus according to claim 11, further comprising means for displaying on the menu screen an item to specify whether to subject the print setting information to an ink-in process.

13. The operation apparatus according to claim 11, further comprising means for displaying on the menu screen a gradation display bar for colors on the screen of the monitor and a gradation display bar for colors printed on the image forming apparatus.

14. The operation apparatus according to claim 11, further comprising means for displaying on the menu screen an item to indicate a margin for misalignment of the specific color.
